(19) United States
(12) Patent Application Publication
(10) Pub. No.: US 2023/0409757 A1
(43) Pub. Date: Dec. 21, 2023

(54) DATA STORAGE SYSTEM AND DATA STORING METHOD

(71) Applicant: DENSO CORPORATION, Kariya-city (JP)

(72) Inventors: HAOLUN HUANG, Kariya-city (JP); XIN XU, Kariya-city (JP)

(21) Appl. No.: 18/459,162

(22) Filed: Aug. 31, 2023

Related U.S. Application Data
(63) Continuation of application No. PCT/JP2022/001555, filed on Jan. 18, 2022.
(60) Provisional application No. 63/156,737, filed on Mar. 4, 2021.

(51) Int. Cl. G06F 21/64; G06F 21/60; G06F 21/62

(52) U.S. Cl. CPC G06F 21/645; G06F 21/602; G06F 21/6218

(57) ABSTRACT

A data storage system includes a node configured to store a blockchain and a data storage server. The node is further configured to, upon receiving the data from a data source, separate the data into confidential data and public data, obtain a tamper proof of the confidential data, send the separated confidential data to the data storage server, and store the public data and the tamper proof on the blockchain. The data storage server is configured to store the confidential data upon receiving the confidential data from the node.

### CROSS REFERENCE TO RELATED APPLICATIONS

This application is a continuation application of International Patent Application No. PCT/JP2022/001555 filed on Jan. 18, 2022, which designated the U.S. and claims the benefit of priority from U.S. Provisional Application No. 63/156,737, filed on Mar. 4, 2021. The entire disclosure of the above application is incorporated herein by reference.

### TECHNICAL FIELD

The subject matter described herein relates in general to a data storage system, a method for storing data, and a computer-readable non-transitory storage medium storing a computer program

### BACKGROUND ART

Recently, a variety types of enterprises or organizations are facing a demand for sharing data to enhance interconnected business activities. For example, automakers (OEMs) share autonomous driving data for improving its driving performance. Such automakers also store and share vehicle related data such as mileages and repair histories for car recycle business. However, maintaining the balance of data usability and its reliability is one of the most important issues to be overcome.

Blockchain technology has been recently developed to provide a distributed data storage mechanism with a difficulty to illegal or unauthorized change to stored data. For example, Hyperledger Fabric provides limited information channel based sharing system to protect confidential data between multiple consortiums in a blockchain network. However, the mechanism is not sufficiently flexible for each participant to treat their own data. Thus, there has been a demand for improved data storage system with flexibility in terms of data treatment for each participant entity.

### SUMMARY

This section provides a general summary of the disclosure, and is not a comprehensive disclosure of its full scope or all of its features.

According to a first aspect of the present disclosure, a data storage system includes a node configured to store a blockchain and a data storage server. The node is further configured to, upon receiving the data from a data source, separate the data into confidential data and public data, obtain a tamper proof of the confidential data, send the separated confidential data to the data storage server, and store the public data and the tamper proof on the blockchain. The data storage server is configured to store the confidential data upon receiving the confidential data from the node.

According to a second aspect of the present disclosure, a method for storing data includes separating data received from a data source into confidential data and public data, obtaining a tamper proof of the confidential data, storing the public data and the tamper proof on a blockchain, and storing the confidential data in a data storage server.

According to a third aspect of the present disclosure, a computer-readable non-transitory storage medium storing a computer program configured to cause at least one processor to separate data received from a data source into confidential data and public data, obtain a tamper proof of the confidential data, store the public data and the tamper proof on a blockchain, and store the confidential data in a data storage server.

### BRIEF DESCRIPTION OF DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, elements may not be drawn to scale.

FIG. 1 schematically illustrates the entire configuration of one embodiment of a data storage system.

FIG. 2 illustrates a block diagram of a business entity according to the embodiment.

FIG. 3 is a diagram illustrating an example of confidential data stored in each server and public data, temper proofs, and data locations stored on a blockchain.

FIG. 4 shows a flowchart of a data storing process.

FIG. 5 shows a flowchart of a data providing process.

### DESCRIPTION OF EMBODIMENTS

Hereinafter, an embodiment of the present disclosure will be described with reference to the drawings.

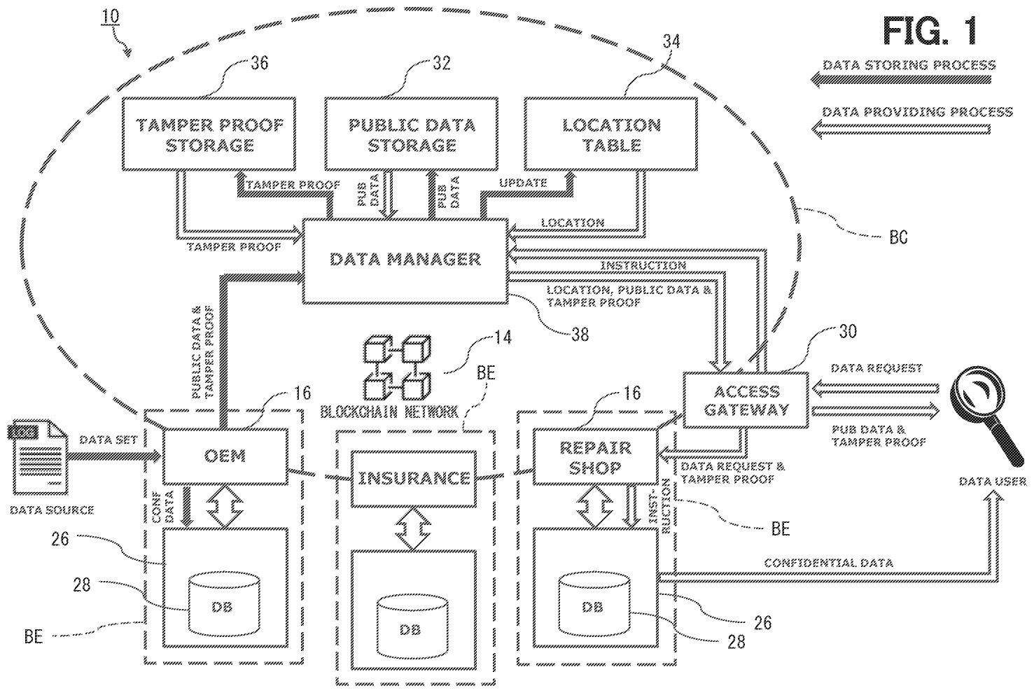

FIG. 1 shows a diagram schematically illustrating one example of a data storage system (hereinafter, referred to as a “system”) 10 according to the present embodiment. The system 10 is configured to store data related to variety types of objects, assets, or things such as cars, motorcycles, smart homes, products, goods, artwork, crops, digital assets, or the like using both on-chain and off-chain layers. Data of such objects is provided from a variety types of data sources such as owners of cars, motorcycles, smart homes, workers or employees of business entities that constitute the system 10, and so on. The system 10 is also configured to provide the stored data to a variety types of data users upon receiving a data request from those users. The data users may include the participant business entities that constitute the system 10, non-participant business entities that do not constitute the system 10 but are authorized to use the system 10, and individual persons who are authorized to use the system 10.

The system 10 is configured to store confidential data on the off-chain (i.e., local servers), whereas public data is stored on the on-chain (i.e., a blockchain BC), as will be described later. Upon receiving a data request, the system 10 provides requested data to the data user by retrieving confidential data from a local server and public data from the blockchain BC. As shown in FIG. 1, the system 10 forms a blockchain consortium in which only authorized or permitted business entities BE (or consortiums) are allowed to participate. In this embodiment, the system 10 is formed of a plurality of business entities BE and an access gateway node 30. The access gateway node 30 is configured to serve as a gateway of the system 10 through which a data request from a data user is input into the system 10.

The participant business entities BE may include, but not necessarily limited to, automakers (OEMs), insurance companies, repair shops (or dealers), banks, and so on. Each business entity BE can serve as a node which forms a blockchain network 14 to store the public data of objects. Each business entity BE also serves as a local server that stores the confidential data of objects in its own database (DB). Therefore, each business entity BE operates in both on-chain layer and off-chain layer.

As shown in FIG. 1, the system 10 includes three business entities BE (an OEM, an insurance company, and a repair shop, for example) in this embodiment. Each business entity BE includes a consortium node 16 (hereinafter, referred to as a “node”), and a data storage server 26 (hereinafter, referred to as a “server”) and all nodes 16 of the participant entities BE are connected to each other to form the blockchain network 14. All nodes 16 store and preserve the blockchain BC on which the public data of objects is recorded. More specifically, each node 16 is configured to store the public data in a public data storage 32 on the blockchain BC. Furthermore, the node 16 also stores data locations in a location table 34 and tamper proofs of the confidential data in a tamper proof storage 36 on the blockchain BC, as will be described later. It should be noted that the nodes 16 may work on a variety type of publicly-known platforms such as Ethereum, Hyperledger Fabric, or the like.

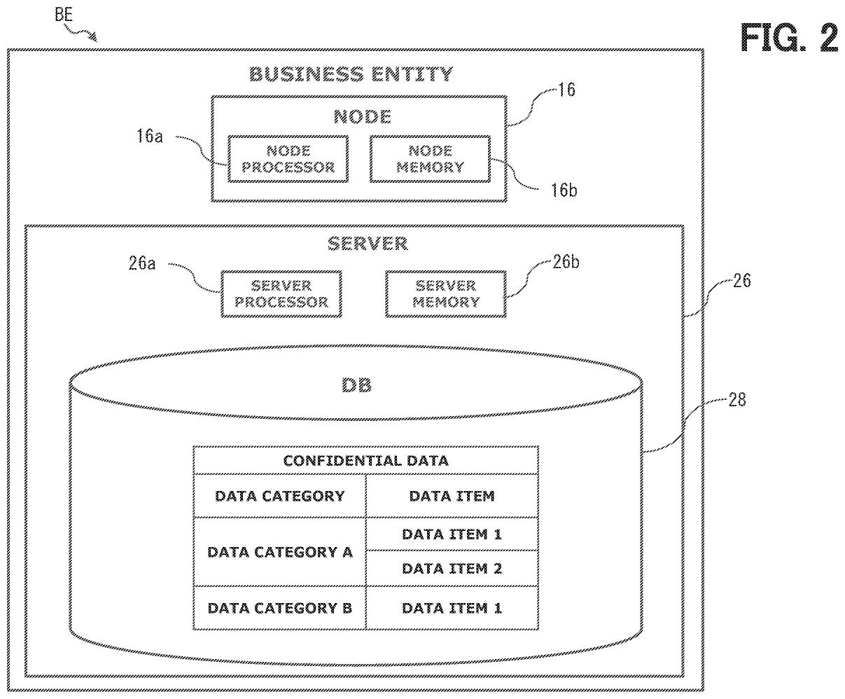

As shown in FIG. 2, the node 16 includes at least one processor (or a node processor 16a) and at least one memory (or a node memory 16b). In one aspect, the node processor 16a may be an electronic processor such as a microprocessor that is capable of performing various functions as described herein when executing programs stored on the node memory 16b. In one embodiment, the node memory 16b may be a random-access memory (RAM), read-only memory (ROM), a hard disk drive, a flash memory, or other suitable memory for storing programs. The programs are computer-readable instructions that, when executed by the node processor 16a, cause the node processor 16a to perform the various functions disclosed herein. Furthermore, some functions by the node processor 16a on the on-chain layer are provided via applications (apps) by executing smart contracts stored on the blockchain BC upon satisfying predetermined conditions, as will be described in detail below.

When the node 16 receives data related to an object from a data source, the node processor 16a is programmed to separate the data into confidential data and public data based on a data policy particularly predefined by each business entity BE. The data is provided to the node 16 in a form of a data set including a plurality of data items. The plurality of data items are categorized into one or more data categories. The data policy is a rule defining how data provided by data sources is treated (i.e., publicly stored on the blockchain BC or confidentially kept in the local server). Each business entity BE freely customizes the data policy according to its business purposes or requests from data sources. For example, the business entity BE may define the data policy to categorize personal data or personally-identifiable data for the data source as “confidential data.” Furthermore, the data policy may be set to categorize data with a high business value for the business entity (e.g., a trade secret) as “confidential data.” On the contrary, the data policy may be defined to categorize non-personal data or personally-unidentifiable data for the data source as “public data.” Furthermore, the data policy may categorize data without a high business value as “public data.”

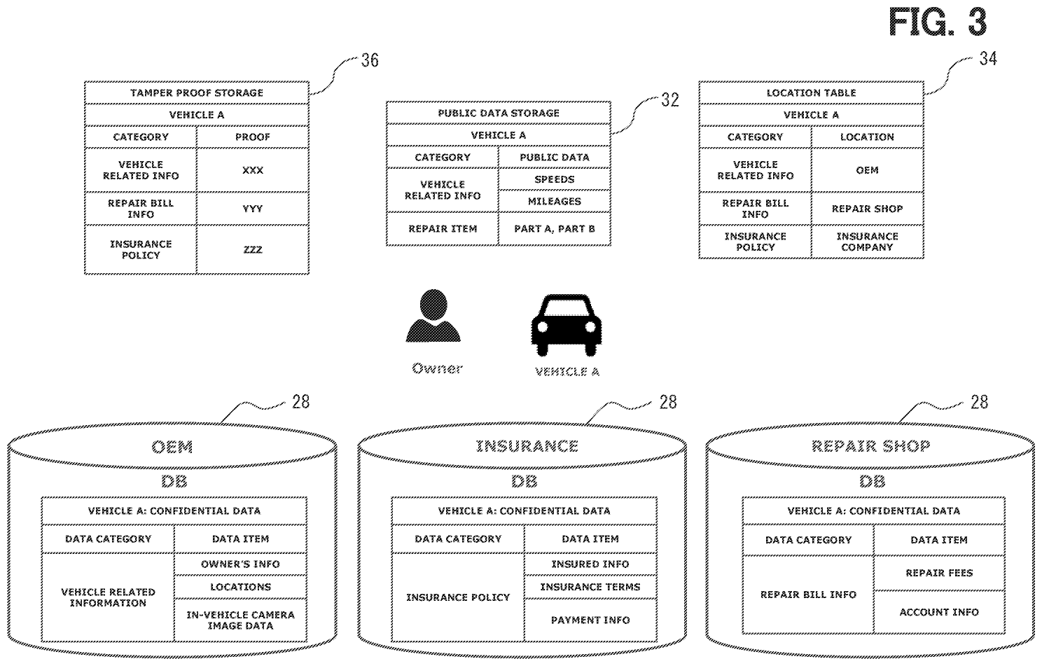

FIG. 3 schematically shows data confidentially stored at each business entity BE and data publicly stored on the blockchain BC. In this example, the object is a particular car (referred to as “vehicle A”) owned by an owner. The automaker (OEM) as one example of the business entities BE may collect vehicle related information of the vehicle A. The vehicle related information includes, for example, owner's information, speeds, locations, mileages, in-vehicle camera image data, and so on. In this example, the vehicle related information is the data category and the data items of owner's information, locations, and in-vehicle camera image data can be categorized as personal data or personally-identifiable data. Therefore, the node processor 16a categorizes these data items as “confidential data.” On the contrary, since the data items of speeds and mileages are personally-unidentifiable data and thus can be publicly shared, the node processor 16a categorizes these data items as “public data.” It should be noted that in this example, the owner of the vehicle A is a data source who provides the vehicle related information of the vehicle A.

The repair shop as another example of the business entities BE may collect, for example, two categories of the data, i.e., “repair item” and “repair bill information” regarding the vehicle A. The data category of the repair item may include “part A” and “part B” that are parts of the vehicle A repaired at the repair shop. The data category of the repair bill information may include, as data items, “repair fees” and “account information”. In this example, all information of the data category of the repair item (i.e., part A and part B) are categorized as the public data by the node processor 16a since these data items do not have personal or personally-identifiable nature. On the contrary, in the data category of the repair bill information, all data items are categorized as the confidential data by the node processor 16a since such information should be confidentially kept. It should be noted that the repair shop (i.e., the node processor 16a) obtains these types of information when a mechanic or the like of the repair shop inputs the information into its DB after repair of the vehicle A was finished. Thus, such a mechanic is a data source in this example.

The insurance company is also another example of the business entity BE and the insurance company may collect one category of “insurance policy” which includes data items of “insured information,” “insurance terms,” and “payment information.” In this example, the node processor 16a categorizes all the data items under the insurance policy as “confidential data” because such information should be also confidentially kept. It should be noted that the insurance company (i.e., the node processor) receives these data items when an employee of the insurance company inputs the information into its database after the insurance contract is formed. Thus, such an employee of the insurance company may serve as a data source.

After separating the received data into the confidential data and the public data, the node processor 16a is programmed to obtain a tamper proof of the confidential data. In this example, the tamper proof is a hash value calculated from the confidential data using a hash function. Furthermore, the node processor 16a is programmed to calculate a hash value of the confidential data for each category of the data. In the example of FIG. 3 as described above, the data category of “vehicle related information” includes three data items (i.e., the owner's information, the locations, and the in-vehicle camera information) as the confidential data. Thus, the node processor 16a calculates a hash value of all the three items using a hash function. Any publicly available hash functions may be used to calculate the hash value. Examples of such functions may include SHA-256 and SHA3-256.

The node processor 16a sends the public data and the tamper proof to a data manager 38 on the blockchain BC, which is an application (app) that runs when a smart contract is executed. The data manager 38 is programmed to store the public data in the public data storage 32 on the blockchain BC upon receiving the public data. The data manager 38 is also programmed to store the tamper proof of the confidential data in the tamper proof storage 36 on the blockchain BC. The data manager 38 stores, in the public data storage 32, the public data with its data category. As shown in FIG. 3, the data items of “speeds” and “mileages” are stored under the data category of the vehicle related information, and the data items of “part A” and “part B” are stored under the data category of the repair item. It should be noted since the data items under the data category of the insurance policy are categorized as “confidential data,” these items are not stored in the public data storage 32 on the blockchain BC.

The data manager 38 is programmed to store, in the tamper proof storage 36, the tamper proof (i.e., a hash value) for each data category. In the example of FIG. 3, the data category of the vehicle related information has the tamper proof of “XXX,” the data category of the repair bill information has the tamper proof of “YYY,” and the data category of the insurance policy has the tamper proof of “ZZZ.”

The node processor 16a is further programmed to store the location table 34 on the blockchain BC. The location table 34 is a table showing correspondence between the confidential data and their locations. The location table 34 is updated by the data manager 38 when the node 16 receives data from a data source. In the present embodiment, the location table 34 indicates the location of the confidential data for each data category. In the above-described example shown in FIG. 3, the location table 34 shows that the data category of “repair bill information” is located (i.e., stored) at the repair shop. Furthermore, the location table 34 shows that the data category of “vehicle related information” and the data category of “insurance policy” are located (i.e., stored) at the OEM and the insurance company, respectively. As shown in this example, the location table 34 does not list the data items themselves.

The node processor 16a is further programmed to verify whether the data request is endorsed. This endorsement is performed by confirming whether the data request includes a certificate certifying that the data user is properly authorized to obtain data through the system 10. If the data request is determined to be endorsed, the node processor 16a is programmed to instruct the server 26 to retrieve and provide the requested confidential data to the data user.

The access gateway node 30 serves as a gateway through which a data request is received and forwarded to a proper business entity BE (more specifically, a proper node 16) which stores the confidential data requested by the data request. As with the node 16 of the business entity BE, the access gateway node 30 includes at least one processor and at least one memory (not illustrated). When the access gateway node 30 receives a data request from a data user, the access gateway node 30 obtains a data location of the requested confidential data from the location table 34 through the data manager 38. In the present embodiment, data is requested for each data category by the data request, and the data manager 38 obtains a data location of the requested data category by referring to the location table 34. Then, the data manager 38 sends the obtained data location to the access gateway node 30. The access gateway node 30 is configured to forward the data request to the node that is identified by the data location.

The access gateway node 30 is also configured to obtain the public data and the tamper proof of the confidential data thorough the data manager 38. For example, if a data user requests for data under the data category of the vehicle related information, the data manager 38 obtains the data items of “speeds” and “mileages” from the public data storage 32. The data manager 38 also obtains the tamper proof “XXX” of the vehicle related information from the tamper proof storage 36. Then, the data manager 38 sends the obtained public data and the tamper proof to the access gateway node 30. The access gateway node 30 sends the public data and the tamper proof to the data user. As described later, the tamper proof is used by the data user to verify whether the confidential data has not tampered since the data was stored. The obtained tamper proof is also sent to the business entity BE where the requested confidential data is stored.

Each business entity BE includes the server 26 (i.e., a local server) having a database (DB) 28. The confidential data sent from the node 16 is stored in the DB 28. As shown in FIG. 2, the server 26 includes at least one processor (or a server processor 26a) and at least one memory (or a server memory 26b). The server processor 26a may be a microprocessor that is capable of performing various functions as described herein when executing programs stored on the server memory 26b. The server memory 26b may be a random-access memory (RAM), read-only memory (ROM), a hard disk drive, a flash memory, or other suitable memory for storing programs. The programs are computer-readable instructions that, when executed by the server processor 26a, cause the server processor 26a to perform the various functions disclosed herein.

The server 26 of each business entity BE is configured to store the confidential data of one or more objects in the DB 28. The server 26 is also configured to update the confidential data upon receiving updated information from a data source. In the present embodiment, each server 26 stores one or more categories of data regarding an object in the DB 28, and each data category includes one or more data items that are sorted as the confidential data. The one or more data categories of the confidential data are unique for each server 26, and thus the one or more data categories of the confidential data stored in one server 26 are different from the data categories of the confidential data stored in the other servers 26. In the example of FIG. 2, the DB 28 stores data categorized into data category A and data category B. The data category A includes two data items (data item 1 and data item 2), whereas the category B includes one data item (data item 1).

More specifically, in the above-described example shown in FIG. 3, the server 26 (the DB 28) of the OEM stores the owner's information, the locations, and the in-vehicle camera image data as “confidential data” under the data category of the vehicle related information. The server 26 of the repair shop stores the repair fees and the account information as “confidential data” under the data category of the repair bill information. The server 26 of the insurance company stores the insured information, the insurance terms, and the payment information as “confidential data” under the data category of the insurance policy.

The server processor 26a is programmed to retrieve the confidential data requested by the data request when receiving an instruction from the node processor 16a. The server processor 26a is also programmed to calculate a hash value of the retrieved confidential data and to compare the calculated hash value to the tamper proof received from the access gateway node 30. The server processor 26a is programmed to send the retrieved confidential data to the data user only if the hash value matches the tamper value (i.e., only if the retrieved confidential data is determined not to be tampered).

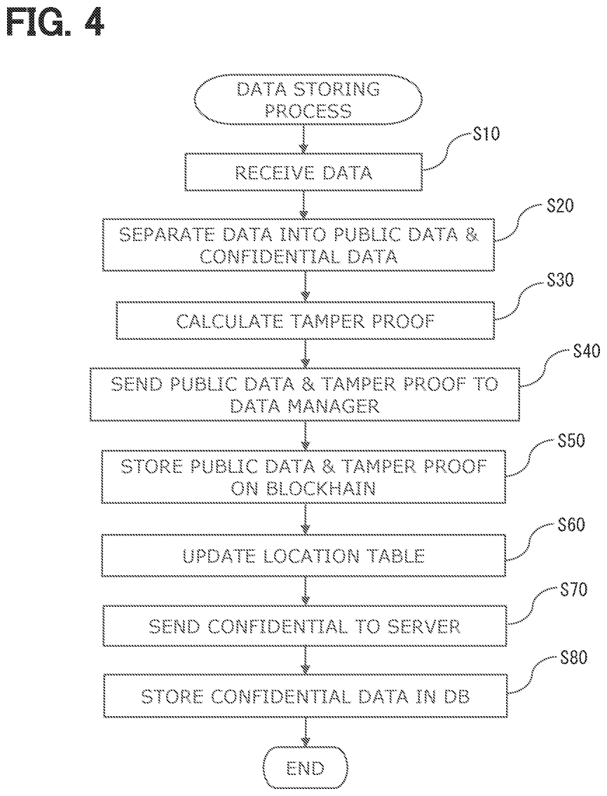

Next, one example of the entire process performed by the system 10 according to the present embodiment will be described. Generally, the system 10 performs a data storing process when data is provided by a data source and a data providing process when a data requested is issued by a data user. The data storing process will be described first with reference to FIGS. 1 and 4. In FIG. 1, the flow of data at the data storing process is indicated by dark arrows. In the following description, it is assumed that an owner of the vehicle A provides a data set regarding the vehicle A to the OEM as described in FIG. 3. The provided data is formed of a single data category of the vehicle related information including owner's information, locations, in-vehicle camera image data, speeds, and mileages.

When the node 16 of the OEM receives the data from the owner at Step 10, the data storing process starts. At Step 20, the node processor 16a separates the data into the confidential data and the public data according to the data policy predefined in advance. In this example, the node processor 16a categorizes the owner's information, the locations, and the in-vehicle camera image data as the confidential data. On the contrary, the node processor 16a categorizes the remaining data (i.e., the speeds and the mileages) as the public data. Then, the node processor 16a obtains the tamper proof of the confidential data for each data category at Step 30. In this example, the node processor 16a calculates a hash value of all the confidential data (i.e., the owner's information, the locations, and the in-vehicle camera image data) as the tamper proof.

Next, the node processor 16a sends the tamper proof and the public data (i.e., the speeds and the mileages) to the data manager 38 at Step 40. Then, the data manager 38 stores the public data and the tamper proof in the public data storage 32 and the tamper proof storage 36, respectively, at Step 50. In this example, the speeds and the mileages are stored in the public data storage 32 under the data category of the vehicle related information as shown in FIG. 3. The tamper proof (YYY) of the confidential data (i.e., the owner's information, the locations, and the in-vehicle camera image data) is stored in the tamper proof storage 36 under the data category of the vehicle related information. The data manager 38 also stores a data location (i.e., the OEM) of the data category of the vehicle related information in the location table 34 at Step 60.

Next, the node processor 16a sends the confidential data (i.e., the owner's information, the locations, and the in-vehicle camera image data) to the server 26 of the OEM at Step 70. When the server 26 receives the confidential data, the server 26 stores the confidential data in the DB 28 at Step 80. Then, the data storing process ends.

As described above, the node processor 16a separates the received data into the confidential data and the public data according to the data policy. Therefore, only the public data is stored on the blockchain BC and the confidential data is kept in the server 26 at the business entity BE. Thus, the confidential data can be confidentially kept at each business entity BE. Furthermore, by setting the data policy, each business entity BE can freely categorize the data as the confidential data and the public data. Thus, the business entity BE can flexibly treat the data according to its business purposes or value of the data. Further, the server 26 stores only the confidential data in own DB 28 and the remaining public data is stored on the blockchain BC. Thus, it is possible to reduce the volume of data stored at each server 26, thereby increasing storage efficiency and reducing costs.

The tamper proofs and the public data are stored in the tamper proof storage 36 and the public data storage, respectively, on the blockchain BC. Thus, the tamper proofs and the public data can be securely stored with a low risk of illegal or unauthorized change.

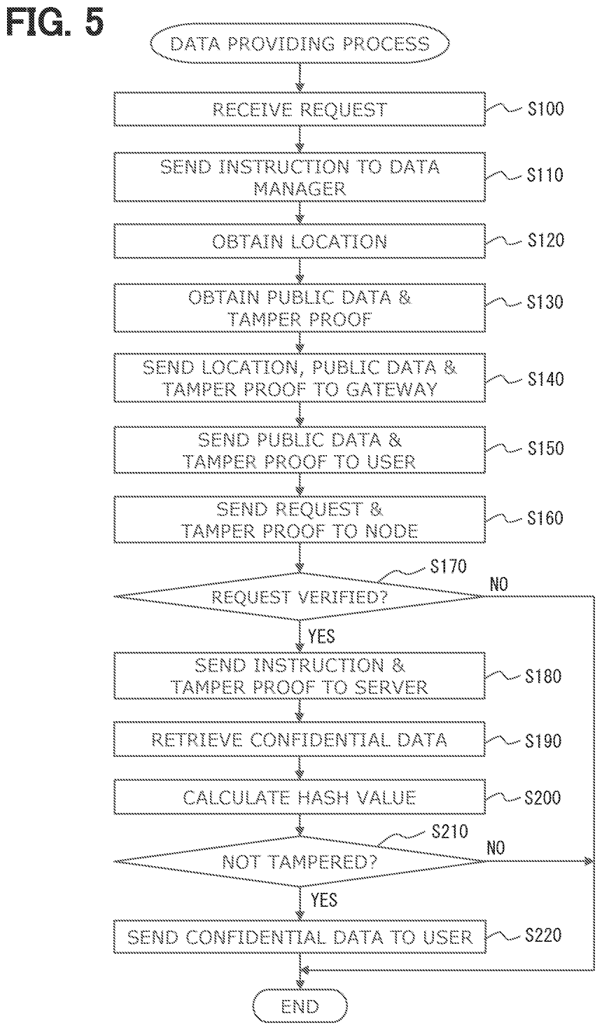

Next, the data providing process will be described with reference to FIGS. 1 and 5. In FIG. 1, the flow of data at the data providing process is indicated by white arrows. In the following description, it is assumed that the insurance company issues a data request to obtain data related to repair of the vehicle A. In this case, the data request includes a request to obtain the two data categories of the repair bill information and the repair item. The data request also includes a certificate certifying that the insurance company has been authorized to obtain data through the system 10. Therefore, in this example, the insurance company serves as both the data user and one business entity BE constituting the system 10.

When the access gateway node 30 receives the data request from the insurance company at Step 100, the data providing process starts. The access gateway node 30 sends an instruction to the data manager 38 to obtain the data location of the confidential data of the requested data category, the public data of the requested data category, and the tamper proof of the confidential data of the requested data category at Step 110. In this example, the access gateway node 30 requests the data manager 38 to obtain the data location of the repair bill information requested by the data request. The access gateway node 30 also requests the data manager 38 to obtain the public data of the repair item requested by the data request. The access gateway node 30 further requests the data manager 38 to obtain the tamper proof of the repair bill information requested by the data request.

Upon receiving the instruction from the access gateway node 30, the data manager 38 obtains the data location of the repair bill information (i.e., the repair shop) by referring to the location table 34 at Step 120. The data manager 38 also obtains the public data of the repair item (i.e., part A and part B) and the tamper proof of the repair bill information (i.e., “YYY”) from the public data storage 32 and the tamper proof storage 36, respectively, at Step 130. Then, the data manager 38 sends the obtained data location, public data, and tamper proof to the access gateway node 30 at Step 140.

When the access gateway node 30 receives the above-described information from the data manager 38, the access gateway node 30 sends the public data (i.e., part A and part B) and the tamper proof (i.e., “YYY”) to the data user at Step 150. Next, the access gateway node 30 forwards the data request and the obtained tamper proof to the node 16 of the business entity BE that is identified by the obtained data location at Step 160. In this example, since the data location indicates the repair bill information is stored at the repair shop, the access gateway node 30 sends the data request and the tamper proof to the node 16 of the repair shop.

When the node 16 of the repair shop receives the data request from the access gateway node 30, the node processor 16a verifies whether the data request is endorsed based on the certificate included in the data request at Step 170. If the node processor 16a verifies that the data request is properly endorsed (Step 170: Yes), the process proceeds to Step 180. On the contrary, if the node processor 16a does not verify that the data request is properly endorsed (Step 170: No), the data providing process ends. In this example, since the insurance company (the data user) has been properly authorized, the process proceeds to Step 180.

At Step 180, the node processor 16a sends the server 26 an instruction to retrieve the requested confidential data. The node processor 16a also sends the server 26 the tamper proof received from the access gateway node 30. In this example, the data category of the repair bill information is requested by the data request, the node processor 16a instructs the server 26 to retrieve the data items categorized as the repair bill information. When the server 26 receives the instruction from the node processor 16a, the server processor 26a retrieves the requested confidential data from the DB 28 at Step 190. In this example, since the server 26 is instructed to retrieve the data items under the repair bill information, the server processor 26a retrieves the repair fees and the account information from the DB 28.

Next, the server processor 26a calculates a hash value of the retrieved confidential data at Step 200. In this example, the server processor 26a calculates the hash value of the repair fees and the account information using a hash function. Then, the server processor 26a verifies whether the retrieved confidential data is not tampered at Step 210. More specifically, the server processor compares the calculated hash value to the tamper proof received from the access gateway node 30. Then, if the calculated hash value matches the tamper proof, the server processor 26a verifies that the retrieved confidential data is not tampered (Step 210: Yes), and the process proceeds to Step 220. On the contrary, if the calculated hash value does not match the tamper proof, the server processor 26a determines that the retrieved confidential data has been tampered (Step 210: No), and the data providing process ends. At Step 220, the server processor 26a sends the retrieved confidential data to the data user. In this case, the server processor 26a sends the repair fees and the account information to the insurance company. Then, the data providing process ends.

As described above, according to the system 10 of the present embodiment, the data user obtains the requested data together with the tamper proof of the confidential data. Thus, the data user can verify whether the confidential data has not been tampered by calculating a hash value of the obtained confidential data and comparing the tamper proof to the calculated hash value. Further, the server 26 confirms that the retrieved confidential data is not tampered before sending the confidential data to the data user. Thus, the system 10 can provide the requested confidential data with a very low risk of tampering.

The access gateway node 30 obtains a data location of confidential data from the location table 34. Thus, the access gateway node 30 can identify the proper business entity BE that stores the requested confidential data based on the data location.

### Modifications to the Embodiment

In the above-described embodiment, the access gateway node 30 dedicatedly receives a data request and handle the data request. However, the nodes 16 of the business entities BE may perform the same function as the access gateway node 30. In this case, the access gateway node 30 may be eliminated. Furthermore, the access gateway node 30 may be configured to receive data from a data source and distribute the received data to the proper business entity BE.

In the above-described embodiment, the access gateway node 30 obtains the tamper proof and sends it to the node 16 of the business entity BE. However, the node 16 may directly obtain the tamper proof through the data manager 38 to verify the confidential data is not tampered. In the above-described embodiment, a plurality of business entities BE constitute the system 10. However, a single business entity may constitute the system 10.

In the above-described embodiment, a data user issues a data request by designating one or more data categories. However, the data request may be done for each data item instead of designating one or more data categories.

1. A data storage system, comprising:
a node configured to store a blockchain; and
a data storage server, wherein
the node is further configured to, upon receiving the data from a data source:
separate the data into confidential data and public data;
obtain a tamper proof of the confidential data;
send the confidential data to the data storage server; and
store the public data and the tamper proof on the blockchain, and
the data storage server is configured to store the confidential data upon receiving the confidential data from the node.

2. The data storage system according to claim 1, wherein
the node is further configured to, upon receiving a data request from a data user:
obtain the tamper proof of the confidential data corresponding to the data request from the blockchain;
obtain the public data corresponding to the data request from the blockchain; and
send the tamper proof and the public data to the data user, and
the data storage server is further configured to send the confidential data corresponding to the data request to the data user upon receiving the data request from the data user.

3. The data storage system according to claim 2, wherein
the node is further configured to send the tamper proof to the data storage server upon receiving the data request from the data user, and
the data storage server is further configured to:
determine whether the confidential data is tampered using the tamper proof; and
send the confidential data to the data user upon determining that the confidential data is not tampered.

4. The data storage system according to claim 2, wherein
the node includes an access gateway node through which the data request is received by the node, and
the access gateway node is configured to send, to the data user, the public data and the tamper proof that are obtained from the blockchain upon receiving the data request from the data user.

5. The data storage system according to claim 4, wherein
the node further includes a plurality of nodes,
the data storage server includes a plurality of servers each corresponding to a respective one of the plurality of nodes,
each of the plurality of servers stores the confidential data that is different from that of other servers,
the node is further configured to store a location table showing a data location of each confidential data on the blockchain, and
the access gateway node is further configured to, upon receiving the data request from the data user:
obtain the data location of the confidential data corresponding to the data request by referring to the location table; and
send the data request to one of the plurality of servers that stores the requested confidential data based on the obtained data location.

6. The data storage system according to claim 1, wherein
the tamper proof is obtained by calculating a hash value of the confidential data.

7. A method for storing data, comprising:
separating data received from a data source into confidential data and public data;
obtaining a tamper proof of the confidential data;
storing the public data and the tamper proof on a blockchain; and
storing the confidential data in a data storage server.

8. The method according to claim 7, further comprising:
obtaining, from the blockchain, the public data and the tamper proof of the confidential data that correspond to a data request from a data user;
sending the public data and the tamper proof to the data user; and
sending the confidential data that corresponds to the data request and is stored in the data storage server to the data user.

9. The method according to claim 8, further comprising:
determining whether the confidential data stored in the data storage server is tampered using the tamper proof obtained from the blockchain; and
sending the confidential data to the data user upon determining that the confidential data is not tampered.

10. A computer-readable non-transitory storage medium storing a computer program configured to cause at least one processor to:
separate data received from a data source into confidential data and public data;
obtain a tamper proof of the confidential data;
store the public data and the tamper proof on a blockchain; and
store the confidential data in a data storage server.

11. The computer-readable non-transitory storage medium according to claim further configured to cause the at least one processor to:
obtain, from the blockchain, the public data and the tamper proof of the confidential data that correspond to a data request from a data user;
send the public data and the tamper proof to the data user; and
send the confidential data that corresponds to the data request and is stored in the data storage server to the data user.

12. The computer-readable non-transitory storage medium according to claim 11 further configured to cause the at least one processor to:
determine whether the confidential data stored in the data storage server is tampered using the tamper proof obtained from the blockchain; and
send the confidential data to the data user upon determining that the confidential data is not tampered.
